(19) United States
(12) Patent Application Publication
(10) Pub. No.: US 2026/0370255 A1
(43) Pub. Date: Nov. 19, 2026

(54) CAPABILITY SIGNALING FOR ADVANCED RECEIVERS TO SUPPORT INTERFERENCE SUPPRESSION FOR PROBABILISTIC SHAPING

(71) Applicant: QUALCOMM Incorporated, San Diego, CA (US)

(72) Inventors: Wei YANG, San Diego, CA (US); Kirill IVANOV, La Jolla, CA (US); Jing JIANG, San Diego, CA (US)

(21) Appl. No.: 19/212,043

(22) Filed: May 19, 2025

(51) Int. Cl. H04B 1/7105; H04L 1/00; H04W 8/22

(52) U.S. Cl. CPC H04B 1/71057; H04L 1/0003; H04L 1/0038; H04W 8/22

(57) ABSTRACT

Certain aspects of the present disclosure provide techniques for wireless communications. An example method includes sending, to a network entity (NE), an indication that the UE has a capability to support a reduced complexity maximum likelihood (ML) receiver configuration that has probabilistic shaping enabled for an interference layer, wherein the reduced complexity ML receiver configuration enables inter-UE interference suppression for a multiple user multiple-input and multiple-output (MIMO) operation mode; and communicating in accordance with the reduced complexity ML receiver configuration.

### INTRODUCTION

### Field of the Disclosure

Aspects of the present disclosure relate to wireless communications, and more particularly, to techniques for transmitting an indication of a capability to support an advanced receiver that enables interference suppression for probabilistic shaping in multiple user multiple-input multiple-output communications.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method of wireless communications by a user equipment (UE). The method includes sending, to a network entity (NE), an indication that the UE has a capability to support a reduced complexity maximum likelihood (ML) receiver configuration that has probabilistic shaping enabled for an interference layer, wherein the reduced complexity ML receiver configuration enables inter-UE interference suppression for a multiple user multiple-input and multiple-output (MIMO) operation mode; and communicating in accordance with the reduced complexity ML receiver configuration.

Certain aspects provide a method of wireless communications by a NE. The method includes receiving, from a UE, an indication that the UE has a capability to support a reduced complexity ML receiver configuration that has probabilistic shaping enabled for an interference layer, wherein the reduced complexity ML receiver configuration enables inter-UE interference suppression for a multiple user MIMO operation mode; and communicating in accordance with the reduced complexity ML receiver configuration.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an example encoding process that supports probabilistic shaping for wireless communications in accordance with described aspects.

FIG. 6 depicts a plot comparing performance between a first UE employing a reduced complexity ML receiver and a second UE employing a conventional receiver.

FIG. 7 depicts a process flow for communications in a network between a network entity and a user equipment for transmitting UE capability signaling for supporting advanced receivers that enable improved interference suppression for probabilistic shaping.

FIG. 8 depicts a method for wireless communications.

FIG. 9 depicts another method for wireless communications.

FIG. 10 depicts aspects of an example communications device.

FIG. 11 depicts aspects of an example communications device.

### DETAILED DESCRIPTION

Aspects of the present disclosure provide apparatuses, methods, processing systems, and computer-readable mediums for transmitting an indication of a capability to support an advanced receiver that enables interference suppression for probabilistic shaping in multiple user multiple-input multiple-output communications.

Wireless communication systems often include one or more devices operating in a multiple-input multiple-output (MIMO) operation mode. In multi-user MIMO (MU-MIMO), a base station serves multiple user equipments (UEs) simultaneously by spatially multiplexing their data streams to improve network capacity. However, a UE experiences increased interference when its transmitted signals are not perfectly orthogonal to transmitted signals of a co-scheduled UE. As used herein, a “co-scheduled UE” refers to a user equipment that sends or receives data at the same time as other co-scheduled UEs within the same time-frequency resources assigned by a common serving network entity.

A UE may be equipped with an advanced receiver configured to enable interference suppression to mitigate interference between transmissions of the UE and one or more co-scheduled UEs. Some UEs may be equipped with an advanced receiver that is a reduced complexity maximum likelihood (ML) receiver. As used herein, a “reduced complexity ML receiver” refers to an advanced receiver that is configured to reduce complexity and computational cost of utilizing a maximum likelihood detection algorithm during MIMO demodulation, for example, to search all possible transmitted symbol combinations and to select one that maximizes a likelihood of receiving a given observed signal. During ML demodulation, the reduced complexity ML receiver computes a distance between a received signal and all possible combinations of candidate transmit signals across all layers. As an example, if there are M possible constellations per layer, then the overall complexity of ML demodulation is represented as M^{L}, where L denotes the number of layers.

Reduced complexity ML receivers may be configured to employ non-linear demodulators for performing various techniques that introduce approximations or heuristics to reduce computational overhead while maintaining sufficient detection performance. A non-linear demodulator detects signals while accounting for non-linear distortions in received signals, rather than assuming linear relationships between transmitted and received signals. This is particularly beneficial in MIMO communications that degrade traditional linear detection methods due to increased non-linear distortions from spatial interference, increased peak-to-average power ratios (PAPR), power amplifier non-linearity, and the like. In some examples, a reduced complexity ML receiver may employ sphere decoding (SD) to restrict a search space to a hypersphere around a received signal. In other examples, a reduced complexity ML receiver may employ lattice reduction-aided detection (LRAD) to convert detection problems into simpler lattice problems by applying transformations to channel matrices to increase orthogonality, thereby improving the conditions of the detection problem.

In some cases, a UE may be equipped with a reduced complexity ML receiver that is configured to enable interference suppression to mitigate interference between transmissions of the UE and a co-scheduled UE that is scheduling transmissions using probabilistic shaping. As used herein, “probabilistic shaping” refers to a technique for generating non-uniformly distributed quadrature amplitude modulation (QAM) constellations in which the probability of selecting constellation points closer to the origin (which require less power) is increased while the probability of selecting constellation points for constellation points further from the origin (which may require more power) is decreased. In conventional QAM, symbols are instead mapped onto constellation points that are all equally probable regardless of distance from an origin, thereby resulting in higher transmission power and increased error probability in noise-limited channels.

UEs equipped with a reduced complexity ML receiver provide increased performance when estimating interference symbols of transmissions scheduled by a co-scheduled UE using probabilistic shaping because the interference layer is shaped in a way that is more exploitable by the non-linear demodulator (e.g. employing sphere decoding or similar techniques). For example, a reduced complexity ML receiver benefits from reduction in interference entropy when probabilistic shaping is used due to the non-uniform distribution being exploitable by the non-linear demodulator, whereas a conventional receiver configured to utilize linear minimum mean square error (LMMSE) detector ignores the interference structure due to a breakdown of the inherent assumption that transmitted symbols are uncorrelated and uniformly distributed. However, without an indication of the capabilities of a UE to support a reduced complexity ML receiver, a network entity cannot determine what information the UE needs (e.g. regarding a co-scheduled UE) to enable the UE to achieve the above-described benefits for interference suppression. A lack of received capability information for a UE thus hinders the ability of an associated serving network entity to effectively communicate with the UE to facilitate interference suppression for transmissions of a co-scheduled UE scheduled using probabilistic shaping. Reduced interference suppression at the UE causes reduced data throughput and increased latency at the UE, thereby degrading performance at the UE and/or the network entity.

Aspects described herein generally relate to UE capability signaling. Some aspects more specifically provide signaling for a UE to send, to a network entity, an indication that the UE has a capability to support a reduced complexity ML receiver configuration that has probabilistic shaping enabled for an interference layer. As used herein, a “reduced complexity ML receiver configuration” refers to a set of one or more capabilities of a UE and a corresponding reduced complexity ML receiver employed by the UE for enabling inter-UE interference suppression for multiple user MIMO communications involving one or more co-scheduled UEs using probabilistic shaping. For example, the reduced complexity ML receiver configuration may be associated with a capability of the UE to support a given reduced complexity ML receiver type utilized by the UE. The network entity serving the UE may then communicate with the UE in accordance with the received indication of the reduced complexity ML receiver configuration supported by the UE. As an example, the network entity may provide specific additional assistance information for enabling improved interference suppression based on the reduced complexity ML receiver configuration. For example, the network entity may provide the UE with additional assistance information such as an indication of a configured modulation order or a shaping parameter associated with a co-scheduled UE. The UE may then communicate in accordance with the reduced complexity ML receiver configuration, such as by using a reduced complexity ML receiver to mitigate interference from a co-scheduled UE based on the received additional information provided by the network entity. This enables the UE to more effectively mitigate interference between its transmissions and transmissions of a co-scheduled UE, thereby increasing data throughput and reducing latency.

In some examples, the reduced complexity ML receiver configuration further includes receiver processing capabilities, such as associated with the reduced complexity ML receiver employed by the UE. In one example, the receiver processing capabilities include a first number of serving layers associated with the UE and a second number of interfering layers associated with a co-scheduled UE to which the UE is able to apply the reduced complexity ML receiver. As used herein, a “serving layer” refers to a data stream transmitted from a network entity (e.g. a base station) that is intended for a specific UE. As used herein an “interfering layer” refers to a data stream transmitted by a network entity that is intended for a co-scheduled UE using shared time-frequency resources with respect to a data stream of a serving layer for a given UE. Thus, the reduced complexity ML receiver configuration may be sent to a network entity to provide the network entity with an understanding of the number of layers (across serving and interfering co-scheduled UEs) using probabilistic shaping to which the UE can apply the reduced complexity ML receiver at a given time. This enables the network entity to improve scheduling efficiency, thereby increasing throughput and decreasing latency experienced at the UE by reducing bit error rates and decoding complexity. In another example, the receiver processing capabilities may further include an indication of a modulation scheme or modulation order threshold associated with each of the first number of serving layers and the second number of interfering layers. This enables the reduced complexity ML receiver configuration to further provide the network entity with additional information that the network entity may use to increase scheduling efficiency. As an example, a UE may support a reduced complexity ML receiver configuration which includes processing capabilities that indicate a first number of serving layers at the UE may be modulated using a maximum modulation order associated with a 256 QAM scheme before applying the reduced complexity ML receiver, while a second number of interfering layers scheduled with probabilistic shaping may be modulated using a maximum modulation order associated with a 1,024 QAM scheme before applying the reduced complexity ML receiver. The network may then schedule transmissions for the UE and the co-scheduled UE on orthogonal resources (e.g. time or frequency) to prevent performance degradation at times when the UE is unable to handle additionally scheduled transmissions for serving layers, or interference layers associated with a co-scheduled UE. Thus, the network entity may better determine when it can efficiently schedule additional transmissions based on the processing capabilities of the reduced complexity ML receiver configuration indicated by the UE, thereby providing the technical benefit of increasing scheduling efficiency and reducing decoding errors due to overload..

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

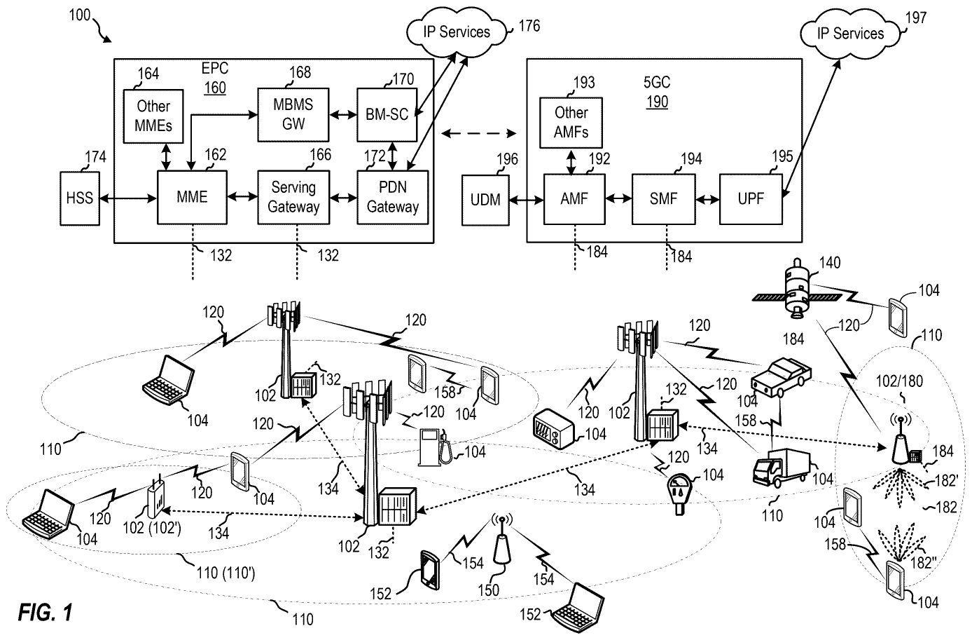

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

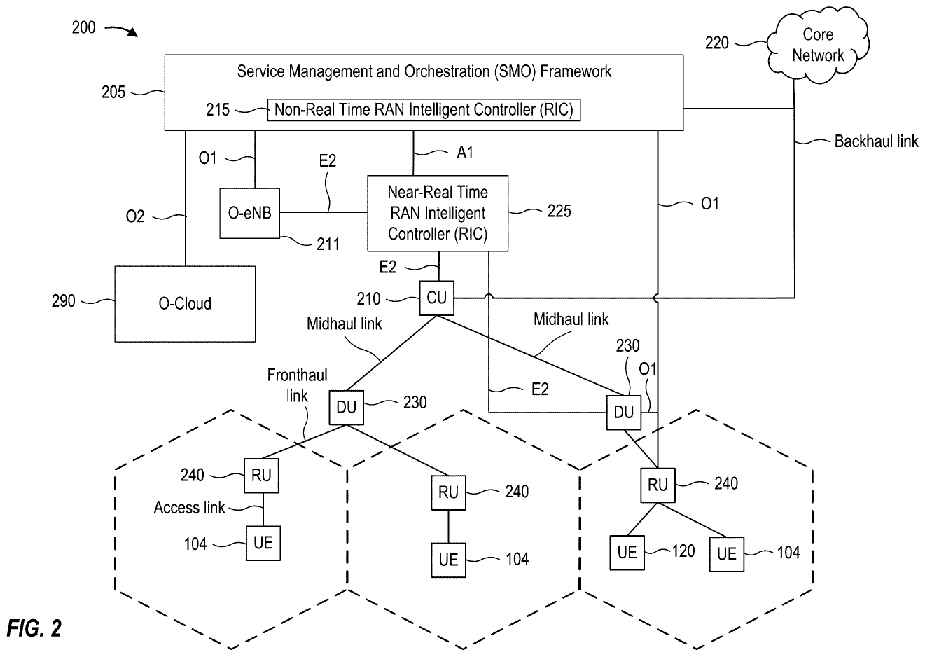

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz 71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information. 5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communications link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

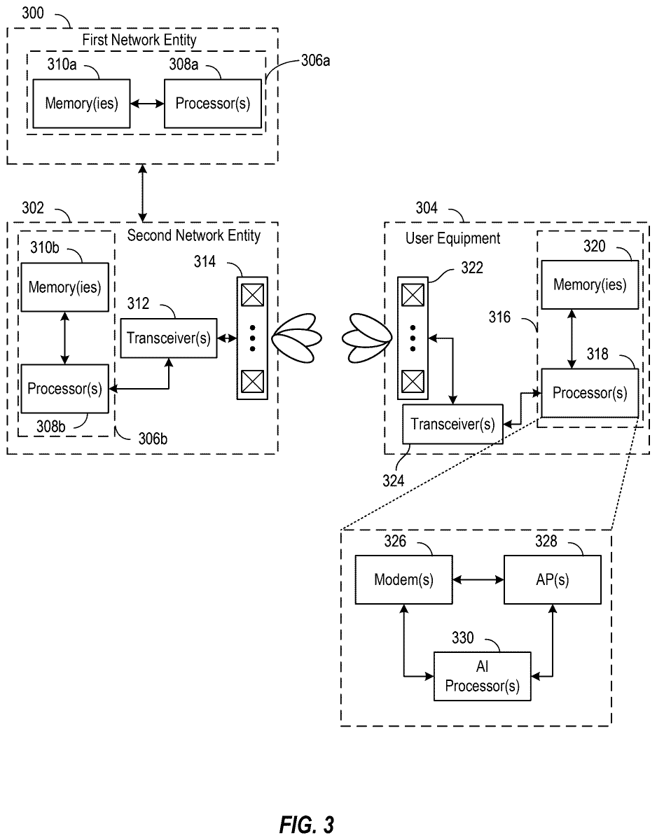

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In s ome examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

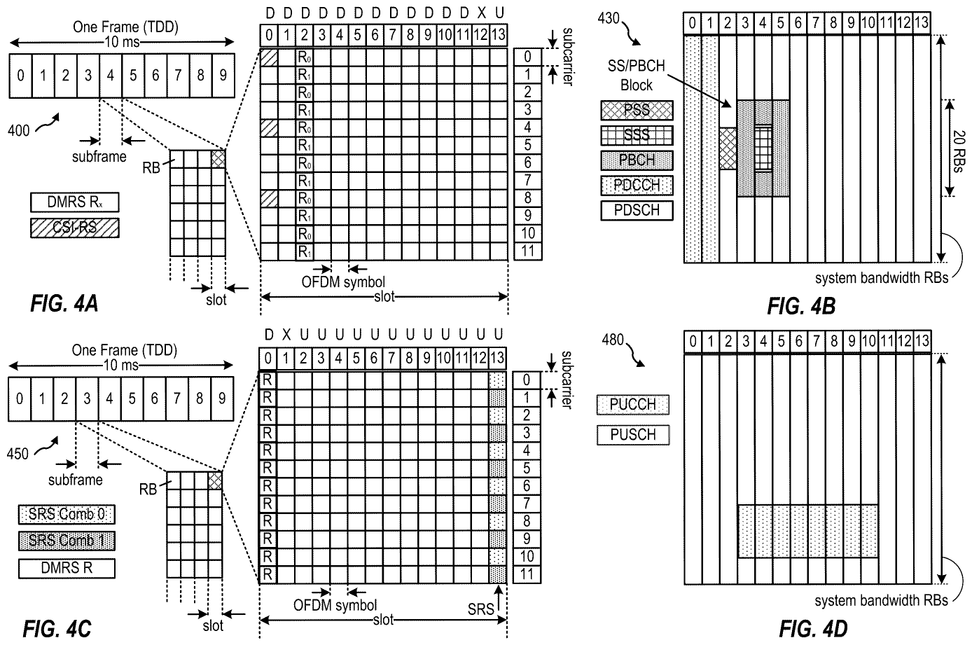

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Encoding Processes Using Probabilistic Shaping for Wireless Communications

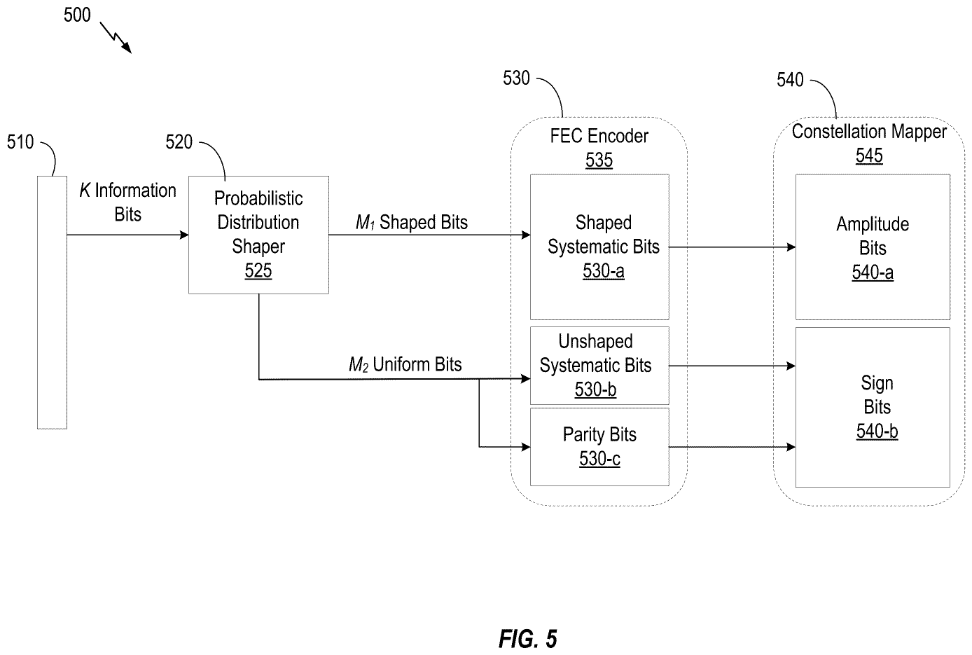

FIG. 5 depicts an example encoding process 500 that supports probabilistic shaping for wireless communications in accordance with described aspects. In particular, process 500 is usable by a UE to generate non-uniformly distributed QAM constellations in which the probability of selecting constellation points closer to the origin (which require less power) is increased while the probability of selecting constellation points for constellation points further from the origin (which may require more power) is decreased when preparing a transmission to be sent to a receiving device. This provides the technical benefit of improving spectral efficiency and reducing average required transmit power (e.g. required signal-to-noise-ratio (SNR)) when sending transmissions.

Process 500 may be performed by a UE, such as UE 104 depicted and described with respect to FIG. 1 or the UE 304 depicted and described with respect to FIG. 3. However, in other aspects, a UE performing process 500 may be another type of wireless communications device, such as those described herein. In some aspects, a UE performing process 500 may be a UE communicating with a network entity in a single-user system. In other aspects, one or more of a first UE and/or a co-scheduled UE may perform process 500, such as in an MU-MIMO system in which a network entity is simultaneously serving multiple UEs using different spatial layers.

At 510, a set of K information bits corresponding to a transmission serve as input for process 500. The set of K information bits correspond to data to be transmitted by a UE performing process 500, such as by transmitting the data to a serving network entity.

At 520, the set of K information bits from 510 are input into a probabilistic distribution shaper 525. The probabilistic distribution shaper 525 transforms (e.g. shapes) the set of K information bits using algorithms configured to generate M₁ shaped bits and M₂ unshaped (e.g. uniform) bits. The M₁ shaped bits are shaped to follow a given probability distribution to ensure that, after modulation, symbols of relatively lower energy are used more frequently than alternative symbols of relatively higher energy, thereby reducing required transmit power and improving power efficiency for the UE. The M₂ unshaped bits remain unchanged to preserve linearity and structure to enable a forward error correction encoder as described in greater detail below.

At 530, M₁ shaped bits and the M₂ unshaped bits are passed to a forward error correction (FEC) encoder 535. The FEC encoder 535 processes the M₁ shaped bits and the M₂ unshaped bits to generate codewords used to support error detection and correction at a receiver employed by a UE performing process 500. In particular, The FEC encoder 535 processes the M₁ shaped bits to obtain shaped systematic bits 530-a that are embedded directly into codewords. The FEC encoder 535 processes the M₂ unshaped bits to generate unshaped systematic bits 530-b and parity bits 530-c. Unshaped systematic bits 530-b are uniformly distributed (e.g. equally likely to be a 1 or a 0) and usable to carry control or structural information, such as sign bits in a modulation scheme. Parity bits 530-c include redundant bits added by FEC encoder 535 to help a receiver to detect and correct errors during decoding. The parity bits 530-c may calculated from shaped systematic bits 530-a and unshaped systematic bits 530-b using specific code, such as a Low-Density Parity-Check (LDPC) code. This enables a receiver employed by a UE performing process 500 to recover an original transmission if some bits are lost or corrupted due to interference, noise, or fading, as examples.

At 540, the bits output by FEC encoder 535 are passed to a constellation mapper 545. Constellation mapper 545 is configured to perform constellation mapping to map the received bits to corresponding modulation symbols (e.g. based on a symbol constellation associated with the modulation symbols) suitable for transmission over the air. Constellation mapper 545 may use a first subset of the received bits including amplitude bits 540-a to determine amplitudes of the mapped modulation symbols. As an example, amplitude bits 540-a may determine a magnitude or distance of a symbol from a center (e.g. origin) of a constellation diagram. Amplitude bits 540-a are derived from shaped systematic bits 530-a and are thus shaped to enable mapping of symbols to amplitude positions that are non-uniformly distributed and configured to prioritize low-energy symbols for reducing average transmit power as described above.

Constellation mapper 545 then uses a second subset of the received bits including sign bits 540-b to determine signs (e.g. polarities, phases, or both) of the mapped modulation symbols. Sign bits 540-b are thus usable to place the mapped symbol in a correct quadrant (e.g. a positive or negative I/Q) of a constellation. Sign bits 540-b may be derived from unshaped systematic bits 530-b and/or parity bits 530-c.

In some aspects, such as during MU-MIMO communications, a co-scheduled UE may use an encoding process in accordance with process 500 described above to schedule transmissions using probabilistic shaping that cause interference at the UE. However, if the UE is equipped with an advanced receiver (e.g. a reduced complexity ML receiver), then the UE may benefit from increased performance when estimating interference symbols of transmissions scheduled by the co-scheduled UE using probabilistic shaping because the interference layer is shaped in a way that is more exploitable by the non-linear demodulator (e.g. employing sphere decoding or similar techniques). The reduced complexity ML receiver employed by the UE benefits from reduction in interference entropy when probabilistic shaping is used by a co-scheduled UE due to the non-uniform distribution being exploitable by the non-linear demodulator of the reduced complexity ML receiver. In contrast, a conventional receiver, such as a receiver configured to utilize LMMSE detectors, ignores the interference structure due to a breakdown of the inherent assumption that transmitted symbols are uncorrelated and uniformly distributed. Thus, a UE employing a reduced complexity ML receiver configured to mitigate interference from a co-scheduled UE utilizing probabilistic shaping experiences more effectively mitigates interference, thereby providing the technical benefit of increased performance at the UE by increasing data throughput and reducing latency.

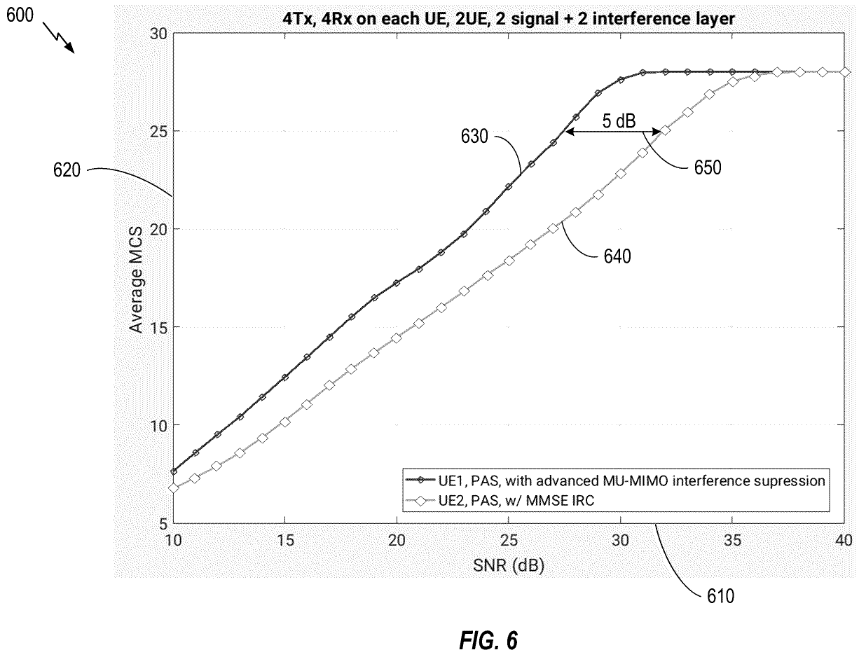

FIG. 6 depicts a plot 600 showing a comparison of performance between a first UE equipped with a reduced complexity ML receiver for MU-MIMO interference suppression and a second UE that utilizes a conventional receiver. The second UE's receiver is configured to rely on minimum mean square error interference rejection combining (MMSE-IRC) for utilizing a filter that suppresses interference by projecting received signals into a null space of the interference. The second UE relies upon identifying a channel of interference (e.g. a spatial channel between an interfering co-scheduled UE's signal and the UEs antenna) to enable the use of MMSE-IRC for interference suppression. It is assumed in the example shown in FIG. 6 that the second UE knows the channel of interference layers. For example, if a DMRS sequence used by the second UE is the same as a DMRS sequence sent by a serving network entity (e.g. a gNB) to a co-scheduled (e.g. an interfering) UE, then the second UE may use the known DMRS sequence to estimate the channel of the interfering layers. In the depicted example, the first and second UE are each equipped with 4 receiving (Rx) antennas and are operating in a MU-MIMO mode. A common network entity (e.g. a gNB) uses outer loop link adaptation (OLLA) to dynamically adjust the modulation and coding scheme (MCS) to achieve a target block error rate (BLER) of 10% for balancing throughput and reliability.

Plot 600 includes a first axis 610 representing a measured signal-to-noise ratio (SNR) measured in decibels (dB) for assessing the quality of received signals relative to background noise (e.g. after mitigation techniques are applied). A second axis 620 represents an average MCS index that reflects the link quality or throughput potential for a given UE. For example, an increased average MCS means the receiver of the UE can support higher modulation and coding for increased throughput and performance.

A first line 630 on plot 600 is associated with the first UE employing the reduced complexity ML receiver for interference suppression. A second line 640 is associated with the second UE relying on MMSE-IRC for interference suppression. As shown at element 650, the first UE experiences a performance gain of about 5 dB at a point where the average MCS for both the first and second UE is 25. This demonstrates that the first UE supports the same throughput (MCS) at a lower SNR, indicating the first UE is more effective at suppressing interference. The performance gain experienced by the first UE is attributed to the improved capabilities of the first UE to support a reduced complexity ML receiver capable of leveraging additional received assistance information about the interference layers (e.g. shaping information, modulation order, etc.) to support demodulation and interference suppression. The additional assistance information may be provided by a serving network entity. In other examples, the additional assistance information may be provided by another UE, such as during sidelink communications. It is assumed the reduced complexity ML receiver employed by the first UE is capable of utilizing a 4 layer (4L) reduced complexity ML detector configured to support 4 simultaneously received data layers.

To experience the performance gain based on improved interference suppression depicted in FIG. 6, the first UE may rely upon additional assistance information from a network entity. However, the network entity requires an understanding of the capabilities of the first UE to support a reduced complexity ML receiver to determine what information the UE needs (e.g. regarding a co-scheduled UE) to enable the UE to achieve the above-described benefits for interference suppression. Accordingly, aspects herein provide UE capability signaling to enable a UE to send, to a network entity, an indication that the UE has a capability to support a reduced complexity ML receiver configuration that has probabilistic shaping enabled for an interference layer. This enables the UE to more effectively mitigate interference between its transmissions and transmissions of a co-scheduled UE, thereby providing the technical benefit of increasing data throughput and reducing latency.

### Example User Equipment Capability Signaling for Advanced Receivers That Enable Improved Interference Suppression for Probabilistic Shaping

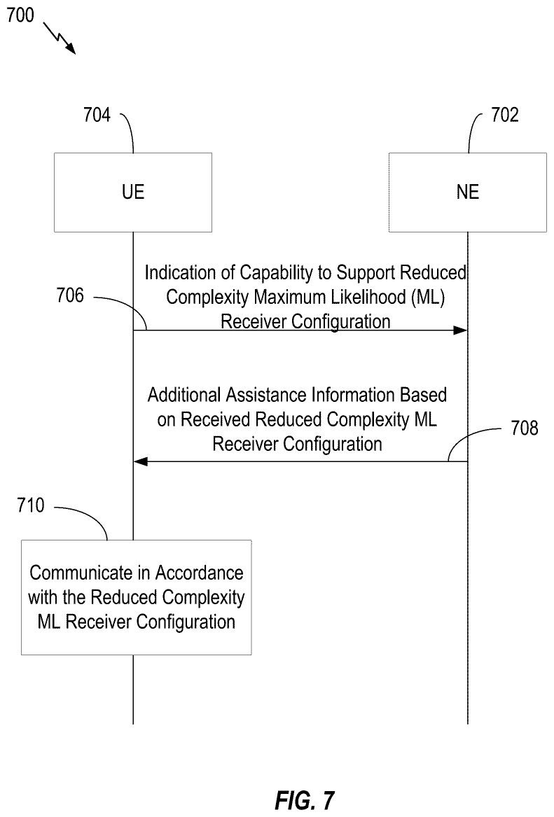

FIG. 7 depicts a process flow 700 for communications between a network entity (NE) 702 and a UE 704. Network entity 702 may further communicate with one or more co-scheduled UEs (not shown) that have one or more transmissions scheduled on the same resources as a scheduled transmission for UE 704.

Signaling in accordance with process flow 700 enables UE 704 to send capability signaling, including to network entity 702, that includes an indication of a capability of UE 704 to support a reduced complexity ML receiver configuration. This provides network entity 702 with information about capabilities of UE 704 and its employed reduced complexity ML receiver that are usable to determine what additional assistance information that network entity 702 should provide to UE 704 to support improved interference suppression. For example, network entity 702 may provide UE 704 with additional assistance information to support interference suppression for transmissions associated with a co-scheduled UE using probabilistic shaping. Thus, process flow 700 enables increased mitigation of interference experienced by UE 704 based on transmissions of a co-scheduled UE using probabilistic shaping, thereby providing the technical benefit of increasing data throughput and reducing latency at UE 704 and/or network entity 702.

In some aspects, the network entity 702 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 704 may be an example of UE 104 depicted and described with respect to FIG. 1 or the UE 304 depicted and described with respect to FIG. 3. However, in other aspects, UE 704 may be another type of wireless communications device and network entity 702 may be another type of network entity or network node, such as those described herein.

At 706, UE 704 sends, to network entity 702, an indication of a capability to support a reduced complexity ML receiver configuration. The reduced complexity ML receiver configuration may enable inter-UE interference suppression for a MU-MIMO operation mode. In particular, the reduced complexity ML receiver configuration indicated by UE 704 may be usable to support inter-UE interference suppression when probabilistic shaping is enabled for at least one interference layer. As used herein an “interference layer” refers to an independent data stream (e.g. a transmit layer) intended for a co-scheduled UE that is instead received unintentionally by a first UE communicating with a shared network entity.

In some aspects, the reduced complexity ML receiver configuration indicated by UE 704 includes an indication of capabilities of UE 704 to support a receiver type having corresponding supported features. As an example, the reduced complexity ML receiver configuration may indicate that UE 704 supports a first receiver type that relies upon network entity 702 to provide both a modulation order and shaping parameter associated with a co-scheduled UE to support interference suppression. In some examples, the modulation order and shaping parameter associated with the co-scheduled UE may be used when encoding and shaping symbols for a transmission. The “modulation order” refers to the number of distinct symbols used in a digital modulation scheme that determines how many bits are encoded in each symbol. Increased modulation order allows more bits per symbol in the presence of sufficient signal quality. As an example, UE 704 or a co-scheduled UE communicating with network entity 702 may be associated with a modulation order that supports a modulation scheme of 16 QAM, 64 QAM, 256 QAM, 1024 QAM, or any other supported modulation scheme. The “shaping parameter” refers to a value or set of information that characterizes the distribution applied to constellation symbols by a UE or co-scheduled UE's encoder. As discussed above, the shaping parameter may be configured to cause the encoder of the co-scheduled UE to apply a non-uniform probability distribution to constellation symbols when a co-scheduled UE is scheduling transmissions using probabilistic shaping.

In some examples, the reduced complexity ML receiver configuration may indicate that UE 704 supports a second receiver type which relies upon network entity 702 to provide an indication (e.g. in downlink control information) of a shaping parameter associated with a co-scheduled UE and is configured to perform blind detection to identify a modulation order associated with the co-scheduled UE to support interference suppression. As used herein, “blind detection” refers to a process performed by a receiver of a UE in which the receiver infers certain transmission parameters (e.g. a modulation order or a shaping parameter associated with a co-scheduled UE) without relying upon received signaling from a network entity regarding the transmission parameter. In some examples, the second receiver type may be configured to utilize blind detection algorithms to test multiple modulation order hypotheses usable to evaluate which hypothesized modulation order best explains a structure of an observed interfering signal from a co-scheduled UE. Evaluating modulation order hypotheses may be performed based on consideration of various metrics such as symbol error variance between received symbol estimates and a nearest constellation point for a given modulation hypothesis, likelihood or log-probability that the received signal was generated under a given modulation hypothesis, residual interference power, or the like. Use of blind detection to identify the modulation order reduces the need for UE 704 to receive explicit signaling from a serving network entity, thereby providing the technical benefit of reducing network entity overhead and improving downlink control coverage.

In some examples, the reduced complexity ML receiver configuration may indicate that UE 704 supports a third receiver type that relies upon network entity 702 to provide explicit signaling of a modulation order associated with a co-scheduled UE and is configured to perform blind detection to identify a shaping parameter associated with the co-scheduled UE to support interference suppression. As an example, the reduced complexity ML receiver employed by UE 704 may examine statistical distributions of received interference signals from a co-scheduled UE to compare them with a set of shaping parameter hypotheses. The third receiver type may be configured to consider various metrics when identifying a shaping parameter hypothesis that best explains observed symbol probabilities. In some examples, the various metrics considered may include, but are not limited to, log-likelihood measurements that represent how probable observed symbols are under a given shaping hypothesis, empirical symbol histograms that may be used to compare observed symbol frequencies to expected symbol distributions under different shaping parameter hypotheses, and Kullback-Leibler (KL) divergences usable to measure a divergence between an observed symbol distribution and an ideal shaped distribution for each shaping parameter hypothesis.

In some aspects, the reduced complexity ML receiver configuration may indicate that UE 704 supports a fourth receiver type that performs blind detection to identify both a modulation order and a shaping parameter associated with the co-scheduled UE to support interference suppression. In some examples, the fourth receiver type may be configured to extend a set of hypotheses to include combinations of hypothesized modulation orders and shaping parameters. For example, the reduced complexity ML receiver employed by UE 704 may be configured to test various hypothesized shaping parameter (e.g. various scalar values shaping “v” from 0 to 3 in steps) in combination with various hypothesized modulation orders (e.g. 64 QAM, 256 QAM, etc.) to determine which combination leads to a decreased residual energy and increased symbol matching for transmissions associated with a co-scheduled UE. The best-performing hypothesis may then be used by the reduced complexity ML receiver of UE 704 to reconstruct and cancel or suppress interference from a co-scheduled UE.

The reduced complexity ML receiver configuration sent by UE 704, which includes an indication of capabilities of UE 704 to support a receiver type, may further indicate that the receiver supported by UE 704 can also support similar interference suppression in the presence of a co-scheduled UE using uniform QAM. As an example, UE 704 may be configured to support similar interference suppression in the presence of uniformly distributed QAM signals associated with a co-scheduled UE transmitting with equal-probability modulation symbols.

In some aspects, the reduced complexity ML receiver configuration sent by UE 704 may also indicate additional UE capabilities to support other receiver processing capabilities associated with an employed reduced complexity ML receiver. In some examples, the receiver processing capabilities include a number of layers (across serving and interfering UEs) to which UE 704 can apply the reduced complexity ML receiver. For example, the reduced complexity ML receiver configuration may indicate that the reduced complexity ML receiver employed by UE 704 can be applied to four layers, where two of the four layers are serving layers with uniform QAM, and two other layers of the four layers are interfering layers with probabilistic shaping enabled. In other aspects, the receiver processing capabilities indicated by the reduced complexity ML receiver configuration include a number of layers (across serving and interfering UEs) with probabilistic shaping enabled to which the UE can apply its reduced complexity ML receiver. As an example, the reduced complexity ML receiver configuration may indicate that the reduced complexity ML receiver employed by UE 704 can be applied to two layers with probabilistic shaping enabled out of four total available layers to which UE 704 can apply the reduced complexity ML receiver. Accordingly, UE 704 would be able to apply the reduced complexity ML receiver to two serving layers with probabilistic shaping and two interfering layers without probabilistic shaping, two serving layers without probabilistic shaping and two interfering layers with probabilistic shaping, or one serving layer with probabilistic shaping and three interfering layers without probabilistic shaping. Similarly, UE 704 could apply the reduced complexity ML receiver to one serving layer without probabilistic shaping, and three interfering layers with probabilistic shaping enabled. Additional or fewer combinations are envisioned for different reduced complexity ML receivers having capabilities to support additional or fewer total layers or layers having probabilistic shaping enabled. In some examples, network entity 702 may leverage the receiver processing capabilities in combination with the receiver type indicated in the reduced complexity ML receiver configuration to more efficiently schedule two pairs of UEs based on an understanding of a capability of both UE 704 and a co-scheduled UE to each support interference suppression when probabilistic shaping is enabled. This provides the technical benefit of reducing interference and improving scheduling efficiency.

In aspects, when UE 704 has a capability to support a reduced complexity ML receiver that is capable of processing a total of four layers (across serving and interfering layers) when operating in a MU-MIMO system, then the reduced complexity ML receiving employed by UE 704 will similarly be able to support the same number of layers (e.g., four) when operating in a single user (SU) MIMO system. Thus, in some examples, the reduced complexity ML receiver configuration supported by UE 704 further enables inter-UE interference suppression when UE 704 is operating in an SU-MIMO operation mode, such as to mitigate interference from a co-scheduled UE using probabilistic shaping.

In other aspects, the receiver processing capabilities may also include an indication of a modulation order threshold that is associated with a highest modulation scheme that the reduced complexity ML receiver employed by UE 704 is capable of reliably detecting, such as based on an allowable error rate in decoding transmitted symbols across both serving and interfering layers. As an example, the receiver processing capabilities may include an indication of a modulation order threshold (across serving and interfering layers) that corresponds to a highest modulation order of 256 QAM for a given reduced complexity ML receiver configuration employed by UE 704. In some examples, the receiver processing capabilities may include a first modulation order threshold for a first number of serving layers associated with UE 704, and a second modulation order threshold for a second number of interfering layers associated with transmissions a co-scheduled UE. Network entity 702 may use an indicated modulation order threshold to increase scheduling efficiency and ensure it does not schedule transmissions at UE 704 or a co-scheduled UE using a modulation scheme that the reduced complexity ML receiver employed by UE 704 is not capable of reliably decoding.

At 708, network entity 702 sends, to UE 704, additional assistance information based on the received reduced complexity ML receiver configuration. As an example, network entity 702 may send signaling to provide an indication of a modulation order or a shaping parameter associated with a co-scheduled UE using probabilistic shaping. Network entity 702 may determine what specific information to provide UE 704 with based on the receiver processing capabilities supported by UE 704, as indicated in the received reduced complexity ML receiver configuration described above. For example, if UE 704 employs a receiver type that relies upon network entity 702 for explicitly signaling a shaping parameter with the co-scheduled UE, then network entity 702 may send UE 704 an indication of the shaping parameter associated with the co-scheduled UE. Additional assistance information may be sent, for example, via downlink control information (DCI) or an RRC message. In some examples, UE 704 may send a reduced complexity ML receiver configuration that includes UE capabilities for supporting a reduced complexity ML receiver of a first type that relies upon network entity 702 for explicit signaling of a modulation order and a shaping parameter associated with a co-scheduled UE. Accordingly, at 708, network entity 702 may send to UE 704 additional assistance information including an indication of both a modulation order and a shaping parameter associated with the co-scheduled UE within DCI or an RRC message. In some examples, network entity 702 may be configured to utilize one or more different RRC parameter values corresponding to different respective employable reduced complexity ML receiver types having different processing capabilities as discussed above at 706. Similarly, the DCI may have corresponding fields based on the different RRC parameters for the different receiver types supported by UE 704.

In some aspects, the additional assistance information sent to UE 704 by network entity 702 may further include an indication of a modulation and coding scheme table (MCS table) used by a co-scheduled UE. This enables network entity 702 to provide UE 704 with an accurate MCS table used by a co-scheduled UE that may be different based on whether the co-scheduled UE has probabilistic shaping enabled or disabled. As used herein an “MCS table” refers to a table defining parameters for data transmissions scheduled by a given UE. In some examples, parameters defined in the MCS table may include, but are not limited to, a modulation order, a coding rate, transport block sizes, and/or spectral efficiency parameters. If a co-scheduled UE is not using probabilistic shaping, then network entity 702 may provide UE 704, which is employing a reduced complexity ML receiver of the first type (e.g. a receiver that relies on the network entity for both shaping parameters and modulation order associated with a co-scheduled UE), with only an indication of a modulation order used by a co-scheduled UE.

At 710, UE 704 communicates in accordance with the reduced complexity ML receiver configuration. UE 704 uses its employed reduced complexity ML receiver to process received transmissions based on the supported capabilities and the received additional assistance information provided by network entity 702 as described above. As an example, if UE 704 is equipped with a reduced complexity ML receiver of the second type discussed above, UE 704 uses an identified modulation order associated with a co-scheduled UE (e.g. identified via blind detection as described above) and a received indication, from network entity 702, of a shaping parameter associated with the co-scheduled UE, to process received transmissions scheduled using probabilistic shaping. By utilizing its employed reduced complexity ML receiver in combination with the received additional assistance information, UE 704 more effectively mitigates interference between its transmissions and transmissions of a co-scheduled UE, thereby increasing data throughput and reducing latency at UE 704 and/or network entity 702.

UE 704 may benefit from a supported reduced complexity ML receiver configuration regardless of UE 704's capability to support encoding and decoding processes for communicating using probabilistic shaping. In other words, UE 704 may benefit from improved interference suppression in an MU-MIMO system involving a co-scheduled UE using probabilistic shaping while simultaneously lacking the capability to encode and decode using probabilistic shaping itself. UE 704 may still utilize an employed reduced complexity ML receiver to detect and suppress and/or cancel interference at a MIMO demodulator.

Accordingly, process flow 700 enables UE 704 to send signaling to network 702 to indicate its capabilities to support a reduced complexity ML receiver configuration corresponding to capabilities of UE 704 and its employed reduced complexity ML receiver. In turn, network entity 702 uses the capability information for UE 704 contained within the reduced complexity ML receiver configuration to determine additional assistance information to provide to UE 704. UE 704 achieves improved interference suppressions capabilities by using it employed reduced complexity ML receiver to leverage the received additional assistance information when processing received transmissions. In particular, the reduced complexity ML receiver may enable improved interference suppression in the presence of received transmissions from a co-scheduled UE using probabilistic shaping. The improved interference suppression at UE 704 provides the technical benefit of increasing data throughput and reducing latency at UE 704 and/or network entity 702.

Note that the process flow illustrated in FIG. 7 is described herein to facilitate an understanding of capability signaling for advanced receivers that enable improved interference suppression for probabilistic shaping, and aspects of the present disclosure may be performed in various manners via alternative or additional signaling and/or operations. In certain aspects, the operations and/or signaling of FIG. 7 may occur in an order different from that described or depicted, and various actions, operations, and/or signaling may be added, omitted, or combined.

### Example Operations of a User Equipment

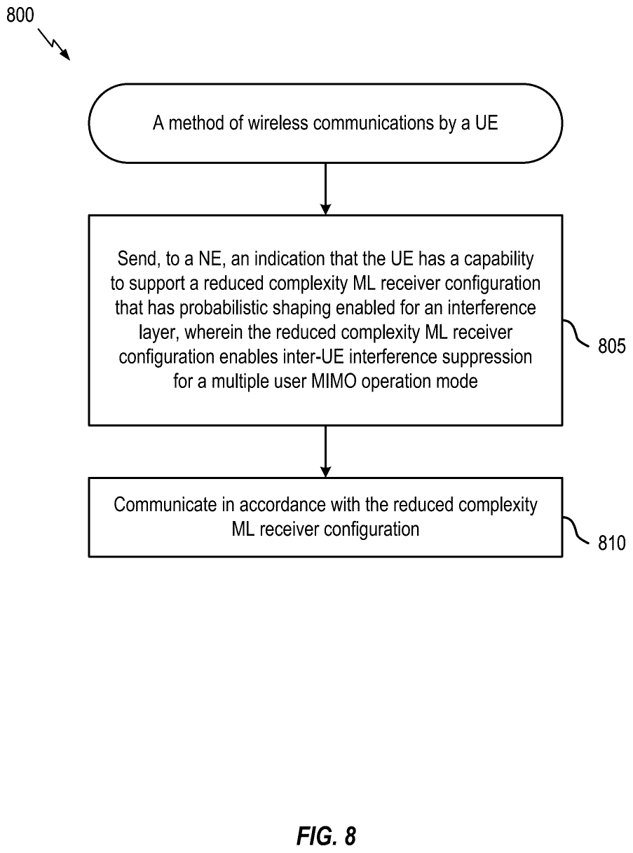

FIG. 8 shows a method 800 for wireless communications by a UE, such as UE 104 of FIG. 1 or UE 304 of FIG. 3.

Method 800 begins at block 805 with sending, to a NE, an indication that the UE has a capability to support a reduced complexity ML receiver configuration that has probabilistic shaping enabled for an interference layer, wherein the reduced complexity ML receiver configuration enables inter-UE interference suppression for a multiple user MIMO operation mode. For example, the sending of the indication that the UE has a capability to support a reduced complexity ML receiver configuration that has probabilistic shaping enabled for an interference layer could correspond to 706 of FIG. 7.

Method 800 then proceeds to block 810 with communicating in accordance with the reduced complexity ML receiver configuration. For example, the communicating in accordance with the reduced complexity ML receiver configuration could correspond to 710 of FIG. 7.

Method 800 thus allows the UE to send a network entity capability information within a reduced complexity ML receiver configuration that provides a network entity with information that is usable to determine what additional assistance information the UE could use to more effectively suppress interference from transmissions of a co-scheduled UE that is using probabilistic shaping. The improved interference suppression provides the technical benefit of improving throughput and reducing latency at the UE and/or the network entity due to the mitigated interference.

In some aspects, method 800 further includes receiving, from the NE, an indication of a modulation order and a shaping parameter associated with a co-scheduled UE.

In some aspects, method 800 further includes receiving, from the NE, an indication of a shaping parameter associated with a co-scheduled UE.

In some aspects, method 800 further includes performing blind detection to identify a modulation order associated with the co-scheduled UE.

In some aspects, identification of the modulation order is based on a set of modulation order hypotheses, the set of modulation order hypotheses based on the shaping parameter associated with the co-scheduled UE.

In some aspects, method 800 further includes receiving, from the NE, an indication of a modulation order associated with a co-scheduled UE.

In some aspects, method 800 further includes performing blind detection to identify a shaping parameter associated with a co-scheduled UE.

In some aspects, method 800 further includes performing blind detection to identify a modulation order and a shaping parameter associated with a co-scheduled UE.

In some aspects, the reduced complexity ML receiver configuration comprises a receiver processing capability including a first number of serving layers associated with the UE and a second number of interfering layers associated with a co-scheduled UE.

In some aspects, the receiver processing capability includes an indication of a modulation scheme associated with each of the first number of serving layers and the second number of interfering layers.

In some aspects, the receiver processing capability includes an indication of a first modulation order threshold for the first number of serving layers associated with the UE.

In some aspects, the receiver processing capability comprises an indication of a modulation order threshold for the second number of interfering layers associated with the co-scheduled UE.

In some aspects, the reduced complexity ML receiver configuration enables inter-UE interference suppression for a SU MIMO operation mode.

In some aspects, method 800 further includes receiving, from the NE, an indication of a MCS table associated with a co-scheduled UE.

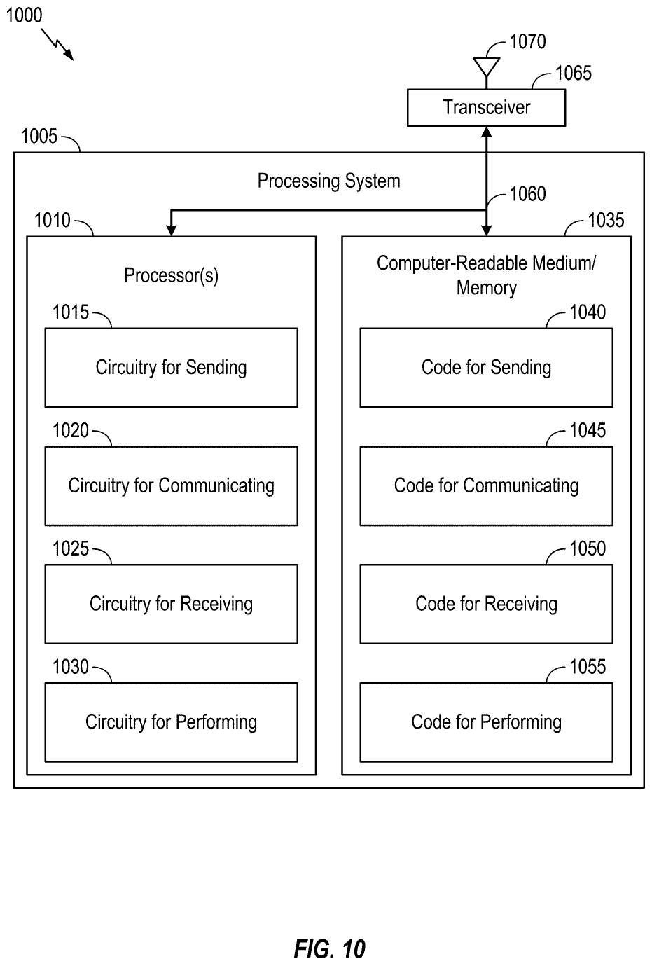

In some aspects, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative operations are possible consistent with this disclosure.

### Example Operations of a Network Entity

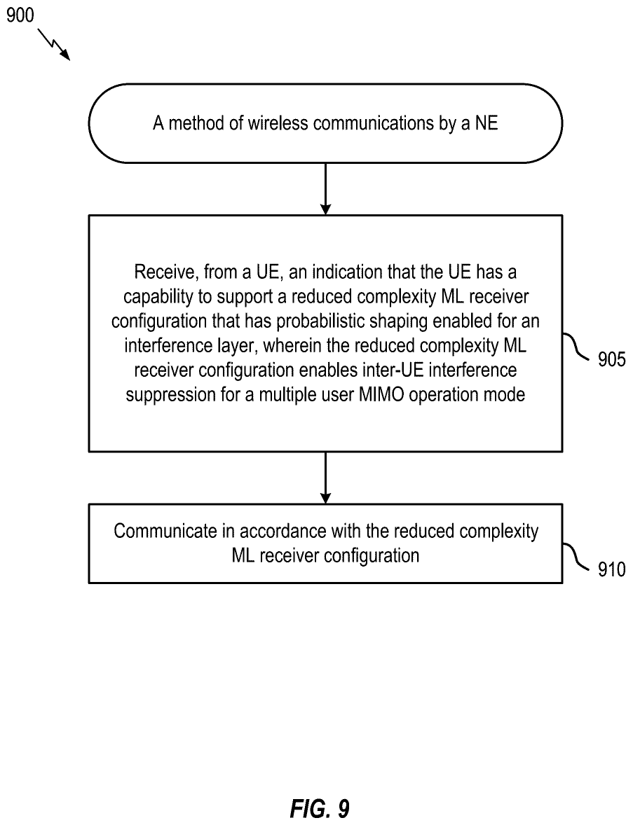

FIG. 9 shows a method 900 for wireless communications by a NE, such as BS 102 of FIG. 1, a first network entity 300 or second network entity 302 of FIG. 3, or a disaggregated base station as discussed with respect to FIG. 2.

Method 900 begins at block 905 with receiving, from a UE, an indication that the UE has a capability to support a reduced complexity ML receiver configuration that has probabilistic shaping enabled for an interference layer, wherein the reduced complexity ML receiver configuration enables inter-UE interference suppression for a multiple user MIMO operation mode. For example, the receiving of the indication that the UE has a capability to support a reduced complexity ML receiver configuration that has probabilistic shaping enabled for an interference layer could correspond to 706 of FIG. 7.

Method 900 then proceeds to block 910 with communicating in accordance with the reduced complexity ML receiver configuration. For example, the communicating in accordance with the reduced complexity ML receiver configuration could correspond to 710 of FIG. 7.

Method 900 thus allows a network entity to receive, from a UE, capability information within a reduced complexity ML receiver configuration that provides the network entity with information that is usable to determine what additional assistance information the UE could use to more effectively suppress interference from transmissions of a co-scheduled UE that is using probabilistic shaping. The improved interference suppression provides the technical benefit of improving throughput and reducing latency at the UE and/or the network entity due to the mitigated interference.

In certain aspects, method 900 further includes sending, to the UE, an indication of a modulation order and a shaping parameter associated with a co-scheduled UE.

In certain aspects, method 900 further includes sending, to the UE, an indication of a shaping parameter associated with a co-scheduled UE.

In certain aspects, method 900 further includes sending, to the UE, an indication of a modulation order associated with a co-scheduled UE.

In some aspects, the reduced complexity ML receiver configuration comprises a receiver processing capability including a first number of serving layers associated with the UE and a second number of interfering layers associated with a co-scheduled UE.

In some aspects, the receiver processing capability includes an indication of a modulation scheme associated with each of the first number of serving layers associated with the UE and the second number of interfering layers associated with the co-scheduled UE.

In some aspects, the receiver processing capability includes an indication of a first modulation order threshold for the first number of serving layers associated with the UE.

In some aspects, the receiver processing capability comprises an indication of a modulation order threshold for the second number of interfering layers associated with the co-scheduled UE.

In some aspects, the reduced complexity ML receiver configuration enables inter-UE interference suppression for a SU MIMO operation mode.

In certain aspects, method 900 further includes sending, to the UE, an indication of a MCS table associated with a co-scheduled UE.

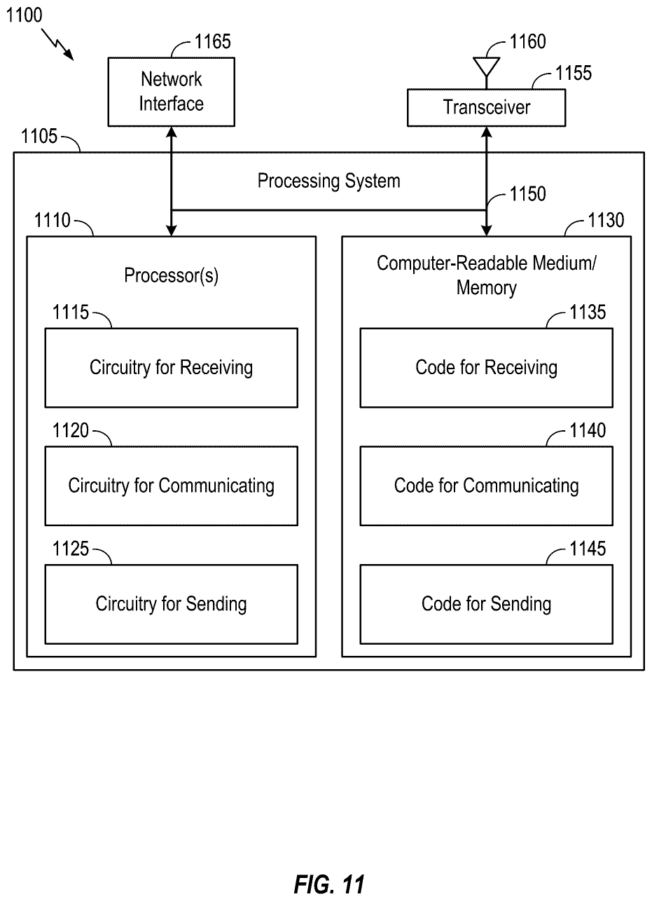

In some aspects, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative operations are possible consistent with this disclosure.

### Example Communications Devices

FIG. 10 depicts aspects of an example communications device 1000 configured for wireless communications. In some aspects, communications device 1000 is a user equipment, such as UE 104 described above with respect to FIG. 1 or UE 304 described with respect to FIG. 3.

The communications device 1000 includes a processing system 1005 coupled to a transceiver 1065 (e.g., a transmitter and/or a receiver). The transceiver 1065 is configured to transmit and receive signals for the communications device 1000 via an antenna 1070, such as the various signals as described herein. The processing system 1005 may be configured to perform processing functions for the communications device 1000, including processing signals received and/or to be transmitted by the communications device 1000.

The processing system 1005 includes one or more processors 1010 and a computer-readable medium/memory 1035. In various aspects, the one or more processors 1010 may be representative of the one or more processors 318 described with respect to FIG. 3. The one or more processors 1010 are coupled to a computer-readable medium/memory 1035 via a bus 1060. In some aspects, the computer-readable medium/memory 1035 may be representative of the one or more memories 320 described with respect to FIG. 3. The computer-readable medium/memory 1035 is a non-transitory computer-readable medium/memory. In certain aspects, the computer-readable medium/memory 1035 is configured to store instructions (e.g., computer-executable code), that when executed by the one or more processors 1010, cause the one or more processors 1010 to perform the method 800 described with respect to FIG. 8, or any aspect related to it, including any operations described in relation to FIG. 8. Note that reference to a processor performing a function of communications device 1000 may include one or more processors performing that function of communications device 1000, such as in a distributed fashion.

In the depicted example, computer-readable medium/memory 1035 stores code (e.g., executable instructions), including code for sending 1040, code for communicating 1045, code for receiving 1050, and code for performing 1055. Processing of the code 1040-1055 may enable and cause the communications device 1000 to perform the method 800 described with respect to FIG. 8, or any aspect related to it. For instance, in some aspects, code for sending 1040 includes code for sending, to a NE, an indication that the UE has a capability to support a reduced complexity ML receiver configuration that has probabilistic shaping enabled for an interference layer, wherein the reduced complexity ML receiver configuration enables inter-UE interference suppression for a multiple user MIMO operation mode. In some aspects, code for communicating 1045 includes code for communicating in accordance with the reduced complexity ML receiver configuration.

The one or more processors 1010 include circuitry configured to implement (e.g., execute) the code stored in the computer-readable medium/memory 1035, including circuitry for sending 1015, circuitry for communicating 1020, circuitry for receiving 1025, and circuitry for performing 1030. Processing with circuitry 1015-1030 may enable and cause the communications device 1000 to perform the method 800 described with respect to FIG. 8, or any aspect related to it. For instance, in some aspects, circuitry for sending 1015 includes circuitry for sending, to a NE, an indication that the UE has a capability to support a reduced complexity ML receiver configuration that has probabilistic shaping enabled for an interference layer, wherein the reduced complexity ML receiver configuration enables inter-UE interference suppression for a multiple user MIMO operation mode. In some aspects, circuitry for communicating 1020 includes circuitry for communicating in accordance with the reduced complexity ML receiver configuration.

More generally, means for communicating, transmitting, sending or outputting for transmission may include the one or more transceivers 324, one or more antenna 322 and/or processing system 316 of the UE 304 illustrated in FIG. 3, transceiver 1065 and/or antenna 1070 of the communications device 1000 in FIG. 10, and/or one or more processors 1010 of the communications device 1000 in FIG. 10. Means for communicating, receiving or obtaining may include the one or more transceivers 324, one or more antennas 322, and/or processing system 316 of the UE 304 illustrated in FIG. 3, transceiver 1065 and/or antenna 1070 of the communications device 1000 in FIG. 10, and/or one or more processors 1010 of the communications device 1000 in FIG. 10.

FIG. 11 depicts aspects of an example communications device configured for wireless communications. In some aspects, communications device 1100 is a network entity, such as BS 102 of FIG. 1, first network entity 300 or second network entity 302 of FIG. 3, or a disaggregated base station as discussed with respect to FIG. 2.

The communications device 1100 includes a processing system 1105 coupled to a transceiver 1155 (e.g., a transmitter and/or a receiver) and/or a network interface 1165. The transceiver 1155 is configured to transmit and receive signals for the communications device 1100 via an antenna 1160, such as the various signals as described herein. The network interface 1165 is configured to obtain and send signals for the communications device 1100 via communications link(s), such as a backhaul link, midhaul link, and/or fronthaul link as described herein, such as with respect to FIG. 2. The processing system 1105 may be configured to perform processing functions for the communications device 1100, including processing signals received and/or to be transmitted by the communications device 1100.

The processing system 1105 includes one or more processors 1110 and a computer-readable medium/memory 1130. In various aspects, one or more processors 1110 may be representative of the one or more processors 308, as described with respect to FIG. 3. The one or more processors 1110 are coupled to the computer-readable medium/memory 1130 via a bus 1150. In certain aspects, the computer-readable medium/memory 1130 is configured to store instructions (e.g., computer-executable code), including code 1135-1145, that when executed by the one or more processors 1110, cause the one or more processors 1110 to perform the method 900 described with respect to FIG. 9, or any aspect related to it, including any operations described in relation to FIG. 9. The computer-readable medium/memory 1130 is a non-transitory computer-readable medium/memory. Note that reference to a processor of communications device 1100 performing a function may include one or more processors of communications device 1100 performing that function, such as in a distributed fashion.

In the depicted example, the computer-readable medium/memory 1130 stores code (e.g., executable instructions), including code for receiving 1135, code for communicating 1140, and code for sending 1145. Processing of the code 1135-1145 may enable and cause the communications device 1100 to perform the method 900 described with respect to FIG. 9, or any aspect related to it. For instance, in some aspects, code for receiving 1135 includes code for receiving, from a UE, an indication that the UE has a capability to support a reduced complexity ML receiver configuration that has probabilistic shaping enabled for an interference layer, wherein the reduced complexity ML receiver configuration enables inter-UE interference suppression for a multiple user MIMO operation mode. In some aspects, code for communicating 1140 includes code for communicating in accordance with the reduced complexity ML receiver configuration.

The one or more processors 1110 include circuitry configured to implement (e.g., execute) the code stored in the computer-readable medium/memory 1130, including circuitry for receiving 1115, circuitry for communicating 1120, and circuitry for sending 1125. Processing with circuitry 1115-1125 may enable and cause the communications device 1100 to perform the method 900 described with respect to FIG. 9, or any aspect related to it. For instance, in some aspects, circuitry for receiving 1115 includes circuitry for receiving, from a UE, an indication that the UE has a capability to support a reduced complexity ML receiver configuration that has probabilistic shaping enabled for an interference layer, wherein the reduced complexity ML receiver configuration enables inter-UE interference suppression for a multiple user MIMO operation mode. In some aspects, circuitry for communicating 1120 includes circuitry for communicating in accordance with the reduced complexity ML receiver configuration.

Various components of the communications device 1100 may provide means for performing the method 900 described with respect to FIG. 9, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1155, antenna 1160, and/or network interface 1165 of the communications device 1100 in FIG. 11, and/or one or more processors 1110 of the communications device 1100 in FIG. 11. Means for communicating, receiving or obtaining may include the one or more transceivers 312, one or more antennas 314, and/or processing system 306 of the first network entity 300 or the second network entity 302 illustrated in FIG. 3, transceiver 1155, antenna 1160, and/or network interface 1165 of the communications device 1100 in FIG. 11, and/or one or more processors 1110 of the communications device 1100 in FIG. 11.

### Example Clauses

Implementation examples are described in the following numbered clauses:
Clause 1: A method of wireless communications by a UE, comprising: sending, to a NE, an indication that the UE has a capability to support a reduced complexity ML receiver configuration that has probabilistic shaping enabled for an interference layer, wherein the reduced complexity ML receiver configuration enables inter-UE interference suppression for a multiple user MIMO operation mode; and communicating in accordance with the reduced complexity ML receiver configuration.
Clause 2: The method of Clause 1, further comprising receiving, from the NE, an indication of a modulation order and a shaping parameter associated with a co-scheduled UE.
Clause 3: The method of any one of Clauses 1-2, further comprising: receiving, from the NE, an indication of a shaping parameter associated with a co-scheduled UE; and performing blind detection to identify a modulation order associated with the co-scheduled UE.
Clause 4: The method of Clause 3, wherein identification of the modulation order is based on a set of modulation order hypotheses, the set of modulation order hypotheses based on the shaping parameter associated with the co-scheduled UE.
Clause 5: The method of any one of Clauses 1-4, further comprising: receiving, from the NE, an indication of a modulation order associated with a co-scheduled UE; and performing blind detection to identify a shaping parameter associated with a co-scheduled UE.
Clause 6: The method of any one of Clauses 1-5, further comprising performing blind detection to identify a modulation order and a shaping parameter associated with a co-scheduled UE.
Clause 7: The method of any one of Clauses 1-6, wherein the reduced complexity ML receiver configuration comprises a receiver processing capability including a first number of serving layers associated with the UE and a second number of interfering layers associated with a co-scheduled UE.
Clause 8: The method of Clause 7, wherein the receiver processing capability includes an indication of a modulation scheme associated with each of the first number of serving layers and the second number of interfering layers.
Clause 9: The method of Clause 7, wherein the receiver processing capability includes an indication of a first modulation order threshold for the first number of serving layers associated with the UE.
Clause 10: The method of Clause 7, wherein the receiver processing capability comprises an indication of a modulation order threshold for the second number of interfering layers associated with the co-scheduled UE.
Clause 11: The method of Clause 7, wherein the reduced complexity ML receiver configuration enables inter-UE interference suppression for a SU MIMO operation mode.
Clause 12: The method of any one of Clauses 1-11, further comprising receiving, from the NE, an indication of a MCS table associated with a co-scheduled UE.
Clause 13: A method of wireless communications by a NE, comprising: receiving, from a UE, an indication that the UE has a capability to support a reduced complexity ML receiver configuration that has probabilistic shaping enabled for an interference layer, wherein the reduced complexity ML receiver configuration enables inter-UE interference suppression for a multiple user MIMO operation mode; and communicating in accordance with the reduced complexity ML receiver configuration.
Clause 14: The method of Clause 13, further comprising sending, to the UE, an indication of a modulation order and a shaping parameter associated with a co-scheduled UE.
Clause 15: The method of any one of Clauses 13-14, further comprising sending, to the UE, an indication of a shaping parameter associated with a co-scheduled UE.
Clause 16: The method of any one of Clauses 13-15, further comprising sending, to the UE, an indication of a modulation order associated with a co-scheduled UE.
Clause 17: The method of any one of Clauses 13-16, wherein the reduced complexity ML receiver configuration comprises a receiver processing capability including a first number of serving layers associated with the UE and a second number of interfering layers associated with a co-scheduled UE.
Clause 18: The method of Clause 17, wherein the receiver processing capability includes an indication of a modulation scheme associated with each of the first number of serving layers associated with the UE and the second number of interfering layers associated with the co-scheduled UE.
Clause 19: The method of Clause 17, wherein the receiver processing capability includes an indication of a first modulation order threshold for the first number of serving layers associated with the UE.
Clause 20: The method of Clause 17, wherein the receiver processing capability comprises an indication of a modulation order threshold for the second number of interfering layers associated with the co-scheduled UE.
Clause 21: The method of Clause 17, wherein the reduced complexity ML receiver configuration enables inter-UE interference suppression for a SU MIMO operation mode.
Clause 22: The method of any one of Clauses 13-21, further comprising sending, to the UE, an indication of a MCS table associated with a co-scheduled UE.

Clause 23: One or more apparatuses, comprising: one or more memories comprising executable instructions; and one or more processors configured to execute the executable instructions and cause the one or more apparatuses to perform a method in accordance with any one of Clauses 1-22.
Clause 24: One or more apparatuses configured for wireless communications, comprising: one or more memories; and one or more processors, coupled to the one or more memories, configured to cause the one or more apparatuses to perform a method in accordance with any one of Clauses 1-22.
Clause 25: One or more apparatuses configured for wireless communications, comprising: one or more memories; and one or more processors, coupled to the one or more memories, configured to perform a method in accordance with any one of Clauses 1-22.
Clause 26: One or more apparatuses, comprising means for performing a method in accordance with any one of Clauses 1-22.
Clause 27: One or more non-transitory computer-readable media comprising executable instructions that, when executed by one or more processors of one or more apparatuses, cause the one or more apparatuses to perform a method in accordance with any one of Clauses 1-22.
Clause 28: One or more computer program products embodied on one or more computer-readable storage media comprising code for performing a method in accordance with any one of Clauses 1-22.
Clause 29: One or more apparatuses configured for wireless communications, comprising: a processing system that includes one or more processors and one or more memories coupled with the one or more processors, the processing system configured to cause the one or more apparatuses to perform a method in accordance with any one of Clauses 1-22.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus, comprising a processing system that includes one or more processors and one or more memories coupled with the one or more processors, the processing system configured to cause a user equipment (UE) to:
send, to a network entity (NE), an indication that the UE has a capability to support a reduced complexity maximum likelihood (ML) receiver configuration that has probabilistic shaping enabled for an interference layer, wherein the reduced complexity ML receiver configuration enables inter-UE interference suppression for a multiple user multiple-input and multiple-output (MIMO) operation mode; and
communicate in accordance with the reduced complexity ML receiver configuration.

2. The UE of claim 1, wherein the processing system is configured to cause the UE to:
receive, from the NE, an indication of a modulation order and a shaping parameter associated with a co-scheduled UE.

3. The UE of claim 1, wherein the processing system is configured to cause the UE to:
receive, from the NE, an indication of a shaping parameter associated with a co-scheduled UE; and
perform blind detection to identify a modulation order associated with the co-scheduled UE.

4. The UE of claim 3, wherein identification of the modulation order is based on a set of modulation order hypotheses, the set of modulation order hypotheses based on the shaping parameter associated with the co-scheduled UE.

5. The UE of claim 1, wherein the processing system is configured to cause the UE to:
receive, from the NE, an indication of a modulation order associated with a co-scheduled UE; and
perform blind detection to identify a shaping parameter associated with a co-scheduled UE.

6. The UE of claim 1, wherein the processing system is configured to cause the UE to:
perform blind detection to identify a modulation order and a shaping parameter associated with a co-scheduled UE.

7. The UE of claim 1, wherein the reduced complexity ML receiver configuration comprises a receiver processing capability including a first number of serving layers associated with the UE and a second number of interfering layers associated with a co-scheduled UE.

8. The UE of claim 7, wherein the receiver processing capability includes an indication of a modulation scheme associated with each of the first number of serving layers and the second number of interfering layers.

9. The UE of claim 7, wherein the receiver processing capability includes an indication of a first modulation order threshold for the first number of serving layers associated with the UE.

10. The UE of claim 7, wherein the receiver processing capability comprises an indication of a modulation order threshold for the second number of interfering layers associated with the co-scheduled UE.

11. The UE of claim 7, wherein the reduced complexity ML receiver configuration enables inter-UE interference suppression for a single user (SU) MIMO operation mode.

12. The UE of claim 1, wherein the processing system is configured to cause the UE to:
receive, from the NE, an indication of a modulation and coding scheme (MCS) table associated with a co-scheduled UE.

13. An apparatus, comprising a processing system that includes one or more processors and one or more memories coupled with the one or more processors, the processing system configured to cause a network entity (NE) to:
receive, from a user equipment (UE), an indication that the UE has a capability to support a reduced complexity maximum likelihood (ML) receiver configuration that has probabilistic shaping enabled for an interference layer, wherein the reduced complexity ML receiver configuration enables inter-UE interference suppression for a multiple user multiple-input and multiple-output (MIMO) operation mode; and
communicate in accordance with the reduced complexity ML receiver configuration.

14. The NE of claim 13, wherein the processing system is configured to cause the NE to:
send, to the UE, an indication of a modulation order and a shaping parameter associated with a co-scheduled UE.

15. The NE of claim 13, wherein the processing system is configured to cause the NE to:
send, to the UE, an indication of a shaping parameter associated with a co-scheduled UE.

16. The NE of claim 13, wherein the processing system is configured to cause the NE to:
send, to the UE, an indication of a modulation order associated with a co-scheduled UE.

17. The NE of claim 13, wherein the reduced complexity ML receiver configuration comprises a receiver processing capability including a first number of serving layers associated with the UE and a second number of interfering layers associated with a co-scheduled UE.

18. The NE of claim 17, wherein the receiver processing capability includes an indication of a modulation scheme associated with each of the first number of serving layers associated with the UE and the second number of interfering layers associated with the co-scheduled UE.

19. The NE of claim 17, wherein the receiver processing capability includes an indication of a first modulation order threshold for the first number of serving layers associated with the UE.

20. A method of wireless communications by a user equipment (UE), comprising:
sending, to a network entity (NE), an indication that the UE has a capability to support a reduced complexity maximum likelihood (ML) receiver configuration that has probabilistic shaping enabled for an interference layer, wherein the reduced complexity ML receiver configuration enables inter-UE interference suppression for a multiple user multiple-input and multiple-output (MIMO) operation mode; and
communicating in accordance with the reduced complexity ML receiver configuration.
